(19) United States
(12) Patent Application Publication
(10) Pub. No.: US 2026/0135889 A1
(43) Pub. Date: May 14, 2026

(54) ELECTRONIC DEVICE FOR SEARCHING FOR BASE STATION, AND OPERATION METHOD OF ELECTRONIC DEVICE

(71) Applicant: Samsung Electronics Co., Ltd., Suwon-si (KR)

(72) Inventors: Seunghoon NAM, Suwon-si (KR); Dongha KIM, Suwon-si (KR)

(21) Appl. No.: 19/441,158

(22) Filed: Jan. 6, 2026

Related U.S. Application Data
(63) Continuation of application No. PCT/KR2024/008281, filed on Jun. 17, 2024.

(30) Foreign Application Priority Data
Jul. 17, 2023 (KR) 10-2023-0092649
Aug. 11, 2023 (KR) 10-2023-0105634

(51) Int. Cl. H04L 65/1016; H04L 65/1069; H04W 48/18

(52) U.S. Cl. CPC H04L 65/1016; H04L 65/1069; H04W 48/18

(57) ABSTRACT

An electronic device is provided. The electronic device includes a communication circuit configured to transmit and receive data via a cellular network, an application processor, and a communication processor, wherein the application processor is configured to, based on receiving a message from the communication processor, activate an internet protocol (IP) multimedia subsystem (IMS) establishment timer that detects whether or not an IMS establishment time, which is a time indicating the maximum time required for the electronic device to be connected to an IMS, has expired, transmit, to the cellular network by using the communication circuit, a packet data network (PDN) connectivity request message requesting a PDN connection between the IMS and the electronic device, in response to receiving a message rejecting the PDN connection, compare a waiting time to reattempt the PDN connection with a remaining time of the IMS establishment time, and based on a result of the comparing, determine to attempt a connection to at least one cellular network different from the cellular network.

### CROSS-REFERENCE TO RELATED APPLICATION(S)

This application is a continuation application, claiming priority under 35 U.S.C. § 365(c), of an International application No. PCT/KR 2024/008281, filed on Jun. 17, 2024, which is based on and claims the benefit of a Korean patent application number 10-2023-0092649, filed on Jul. 17, 2023, in the Korean Intellectual Property Office, and of a Korean patent application number 10-2023-0105634, filed on Aug. 11, 2023, in the Korean Intellectual Property Office, the disclosure of each of which is incorporated by reference herein in its entirety.

### BACKGROUND

### 1. Field

The disclosure relates to an electronic device. More particularly, the disclosure relates to an electronic device configured to transmit and receive Internet protocol multimedia subsystem (IMS) data and to search for a base station in order to provide a voice call service, for example, in a communication environment (e.g., stand alone (SA) and non-stand alone (NSA)).

### 2. Description of Related Art

An Internet protocol multimedia subsystem (IMS) may refer to a system that provides multimedia services based on the Internet protocol (IP). The IMS may provide various multimedia services to user equipment (UE) regardless of a location of the user equipment. The IMS may provide the multimedia services such as voice, audio, video, and data based on the Internet protocol (IP).

The stand alone (SA) or non-stand alone (NSA) may provide voice call service using data, and have difficulty providing the voice call services using a circuit switching (CS) scheme or a code division multiple access (CDMA) scheme.

Electronic devices may perform IP multimedia subsystem (IMS) registration to provide the voice call services using a VoLTE scheme. The electronic devices may have difficulty providing the voice call services without performing the IP multimedia subsystem (IMS) registration.

The electronic devices may process communication requests received from the IP multimedia subsystem (IMS) network and provide multimedia services to users, through the IMS registration process. The IMS registration process may be required each time an electronic device is first connected to the IMS network or a user's location or a network connection changes.

The above information is presented as background information only to assist with an understanding of the disclosure. No determination has been made, and no assertion is made, as to whether any of the above might be applicable as prior art with regard to the disclosure.

### SUMMARY

To provide a voice call services in a communication environment (e.g., stand alone (SA) or non-stand alone (NSA)), the electronic device may attempt the IMS registration. When the IMS registration fails within a limited time (e.g., IMS establishment time), the electronic device may search for another public land mobile network (PLMN) capable of providing voice call services.

When the electronic device attempts the IMS registration, but the IMS registration is rejected or there is no response to the IMS registration attempt, the electronic device may wait until a designated time (e.g., IMS retry time or IMS throttle time) expires in order to reattempt the registration. However, the electronic device has a limitation in that, even when the designated time (e.g., IMS retry time or IMS throttle time) for reattempting the IMS registration exceeds the remaining limited time (e.g., remaining IMS establishment time), the electronic device waits until the limited time (e.g., IMS establishment time) completely expires before switching to search for another PLMN.

Aspects of the disclosure are to address at least the above-mentioned problems and/or disadvantages and to provide at least the advantages described below. Accordingly, an aspect of the disclosure is to provide an electronic device configured to transmit and receive Internet protocol multimedia subsystem (IMS) data and to search for a base station in order to provide a voice call service.

Additional aspects will be set forth in part in the description which follows and, in part, will be apparent from the description, or may be learned by practice of the presented embodiments.

In accordance with an aspect of the disclosure, an electronic device is provided. The electronic device includes a communication circuit configured to transmit and receive data via a cellular network, an application processor, and a communication processor, wherein the application processor is configured to, based on receiving a message from the communication processor, activate an internet protocol (IP) multimedia subsystem (IMS) establishment timer that detects whether or not an IMS establishment time, which is a time indicating a maximum time required for the electronic device to be connected to an IMS, has expired, transmit, to the cellular network by using the communication circuit, a packet data network (PDN) connectivity request message requesting a PDN connection between the IMS and the electronic device, in response to receiving a message rejecting the PDN connection, compare a waiting time to reattempt the PDN connection with a remaining time of the IMS establishment time, and based on a result of the comparing, determine to attempt a connection to at least one cellular network different from the cellular network.

In accordance with another aspect of the disclosure, an electronic device is provided. The electronic device includes a communication processor and an application processor, wherein the application processor is configured to receive, using the communication processor, a message indicating a failure to establish a communication connection with a public land mobile network (PLMN) or a message indicating no response for a designated time, based on receiving the message indicating the failure to establish the communication connection or the message indicating no response for the designated time, receive, using the communication processor, information about an internet protocol (IP) multimedia subsystem (IMS) retry time, and based on a size of the IMS retry time and a size of a remaining IMS establishment time satisfying a designated condition, determine to change the PLMN to which the communication connection is to be attempted.

In accordance with another aspect of the disclosure, A method performed by an electronic device is provided. The method includes activating, by the electronic device, an IP multimedia subsystem (IMS) establishment timer that detects whether or not an IMS establishment time, which is a time indicating a maximum time required for the electronic device to be connected to the IMS, has expired while initiating a connection procedure with an IMS via a cellular network, controlling, by the electronic device, a communication processor to transmit, to the cellular network, a packet data network (PDN) connectivity request message requesting a PDN connection between the IMS and the electronic device, receiving, from the cellular network, a message rejecting the PDN connection, in response to receiving the message rejecting the PDN connection, comparing, by the electronic device, a waiting time to reattempt the PDN connection with a remaining time of an IMS establishment time, and based on a result of the comparing, determining, by the electronic device, to attempt a connection to at least one cellular network different from the cellular network.

The electronic device determines to immediately search for another PLMN, instead of waiting until the limited time (e.g., the IMS establishment time) completely expires, in the situation where the designated time (e.g., the IMS retry time or the IMS throttle time) is greater than the remaining limited time (e.g., the IMS establishment time), in order to reattempt the registration.

The electronic device increases the network switching speed by relatively quickly attempting to switch to another PLMN in the situations where it is difficult to provide the voice call services.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2 is a block diagram of an electronic device for supporting legacy network communication and fifth generation (5G) network communication according to an embodiment of the disclosure;

FIG. 3 is a diagram illustrating a protocol stack structure of a network of legacy communication and/or 5G communication according to an embodiment of the disclosure;

FIGS. 4A and 4B are diagrams illustrating wireless communication systems that provide networks of legacy communication and/or 5G communication according to various embodiments of the disclosure;

FIG. 5 is a diagram illustrating an electronic device and a cellular network according to an embodiment of the disclosure;

FIG. 6 is a block diagram of the electronic device according to an embodiment of the disclosure;

FIGS. 7A and 7B are flowcharts illustrating an operation method of an electronic device according to various embodiments of the disclosure;

FIG. 8A illustrates a first embodiment in which a determination is made to attempt a switching to another PLMN based on an IMS throttle timer value and an IMS establishment timer value according to an embodiment of the disclosure; and

FIG. 8B illustrates a second embodiment in which a determination is made to attempt switching to another PLMN based on the IMS registration retry timer value and the IMS establishment timer value according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi™) chip, a Bluetooth™ chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

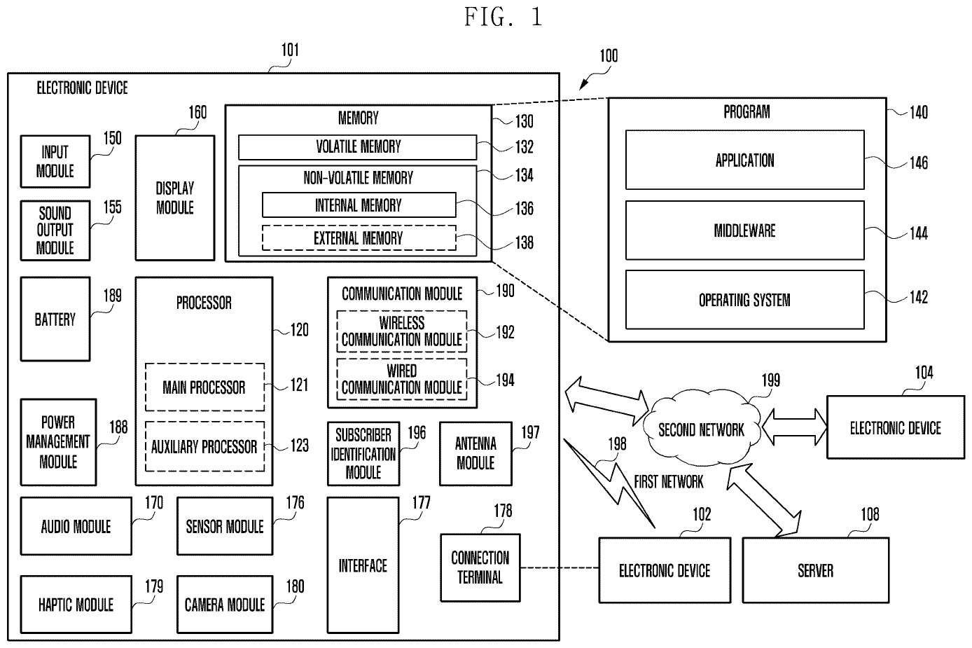

FIG. 1 is a block diagram illustrating an electronic device in a network environment according to an embodiment of the disclosure.

Referring to FIG. 1, an electronic device 101 in a network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connection terminal 178, a haptic module 179, a camera module 180, a power management module 188, a battery 189, a communication module 190, a subscriber identification module (SIM) 196, or an antenna module 197. In some embodiments, at least one of the components (e.g., the connection terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., the electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

The connection terminal 178 may include a connector via which the electronic device 101 may be physically connected with the external electronic device (e.g., the electronic device 102). According to an embodiment, the connection terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi™) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beamforming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or user plane (U-plane) latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices (e.g., the electronic devices 102 and 104 and the server 108). For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

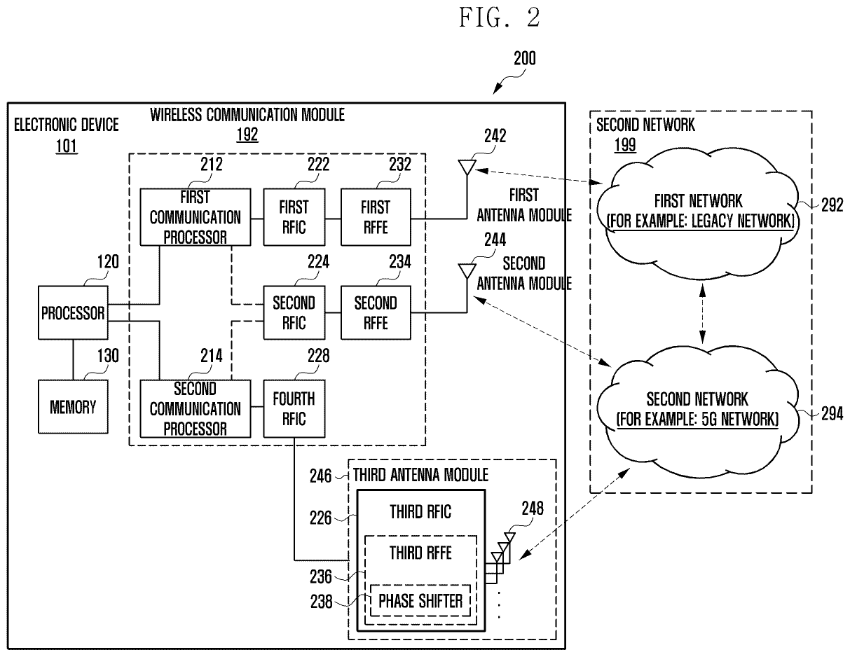

FIG. 2 is a block diagram of an electronic device for supporting legacy network communication and 5G network communication according to an embodiment of the disclosure.

Referring to FIG. 2, block diagram 200 illustrates that an electronic device 101 may include a first communication processor 212, a second communication processor 214, a first radio frequency integrated circuit (RFIC) 222, a second RFIC 224, a third RFIC 226, a fourth RFIC 228, a first radio frequency front end (RFFE) 232, a second RFFE 234, a first antenna module 242, a second antenna module 244, and an antenna 248. The electronic device 101 may further include a processor 120 and memory 130. The second network 199 may include a first network 292 and a second network 294. According to another embodiment, the electronic device 101 may further include at least one of the components described in FIG. 1, and the second network 199 may further include at least one other network. According to an embodiment, the first communication processor 212, the second communication processor 214, the first RFIC 222, the second RFIC 224, the fourth RFIC 228, the first RFFE 232, and the second RFFE 234 may form at least a portion of the wireless communication module 192. According to another embodiment, the fourth RFIC 228 may be omitted or included as a portion of the third RFIC 226.

The first communication processor 212 may support establishment of a communication channel in a band to be used for wireless communication with the first network 292, and legacy network communication via the established communication channel. According to various embodiments, the first network may be a legacy network including a second generation (2G), third generation (3G), fourth generation (4G), or long term evolution (LTE) network. The second communication processor 214 may support establishment of a communication channel corresponding to a designated band (e.g., about 6 giga hertz (GHz) to about 60 GHz) among the bands to be used for the wireless communication with the second network 294, and 5G network communication via the established communication channel. According to various embodiments, the second network 294 may be a 5G network defined by the third generation partnership project (3GPP). Additionally, according to an embodiment, the first communication processor 212 or the second communication processor 214 may support establishment of a communication channel corresponding to another designated band (e.g., about 6 GHz or less) among the bands to be used for wireless communication with the second network 294, and the 5G network communication via the established communication channel. According to an embodiment, the first communication processor 212 and the second communication processor 214 may be implemented in a single chip or a single package. According to various embodiments, the first communication processor 212 or the second communication processor 214 may be formed in a single chip or a single package with the processor 120, the auxiliary processor 123, or the communication module 190.

Upon transmission, the first RFIC 222 may convert a baseband signal generated by the first communication processor 212 into a radio frequency (RF) signal of about 700 MHz to about 3 GHz used in the first network 292 (e.g., a legacy network). Upon reception, an RF signal may be acquired from the first network 292 (e.g., a legacy network) via an antenna (e.g., the first antenna module 242) and may be preprocessed via an RFFE (e.g., the first RFFE 232). The first RFIC 222 may convert the preprocessed RF signal into a baseband signal so that the preprocessed RF signal may be processed by the first communication processor 212.

Upon transmission, the second RFIC 224 may convert the baseband signal generated by the first communication processor 212 or the second communication processor 214 into an RF signal (hereinafter, a 5G Sub6 RF signal) of a Sub6 band (e.g., about 6 GHz or less) used in the second network 294 (e.g., a 5G network). Upon reception, the 5G Sub6 RF signal may be acquired from the second network 294 (e.g., the 5G network) via the antenna (e.g., the second antenna module 244) and preprocessed via the RFFE (e.g., the second RFFE 234). The second RFIC 224 may convert the preprocessed 5G Sub6 RF signal into the baseband signal so that the preprocessed 5G Sub6 RF signal may be processed by the corresponding communication processor among the first communication processor 212 or the second communication processor 214.

The third RFIC 226 may convert the baseband signal generated by the second communication processor 214 into an RF signal (hereinafter, a 5G Above6 RF signal) of a 5G Above6 band (e.g., about 6 GHz to about 60 GHz) to be used in the second network 294 (e.g., the 5G network). Upon reception, the 5G Above6 RF signal may be acquired from the second network 294 (e.g., the 5G network) via the antenna (e.g., the antenna 248) and preprocessed via a third RFFE 236. The third RFIC 226 may convert the preprocessed 5G Above6 RF signal into the baseband signal so that the preprocessed 5G Above6 RF signal may be processed by the second communication processor 214. According to an embodiment, the third RFFE 236 may be formed as a portion of the third RFIC 226.

According to an embodiment, the electronic device 101 may include the fourth RFIC 228 separately from or at least as a portion of the third RFIC 226. In this case, the fourth RFIC 228 may convert the baseband signal generated by the second communication processor 214 into an RF signal (hereinafter, an IF signal) of an intermediate frequency band (e.g., about 9 GHz to about 11 GHz) and then transmit the IF signal to the third RFIC 226. The third RFIC 226 may convert the IF signal into the 5 G Above6 RF signal. Upon reception, the 5G Above6 RF signal may be received from the second network 294 (e.g., the 5G network) via the antenna (e.g., the antenna 248) and converted into the IF signal by the third RFIC 226. The fourth RFIC 228 may convert the IF signal into the baseband signal so that the IF signal may be processed by the second communication processor 214.

According to an embodiment, the first RFIC 222 and the second RFIC 224 may be implemented as at least a portion of a single chip or a single package. According to an embodiment, the first RFFE 232 and the second RFFE 234 may be implemented as at least a portion of a single chip or a single package. According to an embodiment, at least one antenna module of the first antenna module 242 or the second antenna module 244 may be omitted or coupled to with another antenna module to process RF signals of corresponding multiple bands.

According to an embodiment, the third RFIC 226 and the antenna 248 may be disposed on the same substrate to form a third antenna module 246. For example, the wireless communication module 192 or the processor 120 may be disposed on a first substrate (e.g., a main PCB). In this case, the third RFIC 226 may be disposed on a partial region (e.g., lower surface) of a second substrate (e.g., sub PCB) separate from the first substrate, and the antenna 248 may be disposed on another partial region (e.g., upper surface), thereby forming the third antenna module 246. By disposing the third RFIC 226 and the antenna 248 on the same substrate, it is possible to reduce a length of a transmission line therebetween. This may reduce, for example, a loss (e.g., attenuation) of signals in a high-frequency band (e.g., about 6 GHz to about 60 GHz) used in the 5G network communication due to the transmission line. As a result, the electronic device 101 may improve the quality or speed of communication with the second network 294 (e.g., the 5G network).

According to an embodiment, the antenna 248 may be formed as an antenna array including a plurality of antenna elements that may be used for beamforming. In this case, the third RFIC 226 may include, as a part of the third RFFE 236, for example, a plurality of phase shifters 238 corresponding to a plurality of antenna elements. Upon transmission, each of the plurality of phase shifters 238 may shift a phase of the 5 G Above6 RF signal to be transmitted to the outside (e.g., a base station of the 5G network) of the electronic device 101 via the corresponding antenna element. Upon reception, each of the plurality of phase shifters 238 may shift the phase of the 5G Above6 RF signal received from the outside via the corresponding antenna element to the same or substantially the same phase. This enables the transmission or reception via the beamforming between the electronic device 101 and the outside.

The second network 294 (e.g., the 5G network) may operate independently (e.g., stand alone (SA)) from the first network 292 (e.g., the legacy network) or operate while connected (e.g., non-stand alone (NSA)) to the first network 292 (e.g., the legacy network). For example, the 5G network may only have an access network (e.g., a 5G radio access network (RAN) or next generation RAN (NG RAN)) and may not include core network (e.g., next generation core (NGC)). In this case, the electronic device 101 may access the access network of the 5G network and then access an external network (e.g., the Internet) under the control of the core network (e.g., evolved packed core (EPC)) of the legacy network. Protocol information (e.g., LTE protocol information) for communicating with the legacy network or protocol information (e.g., new radio (NR) protocol information) for communicating with the 5G network may be stored in the memory 230 and accessed by other components (e.g., the processor 120, the first communication processor 212, or the second communication processor 214).

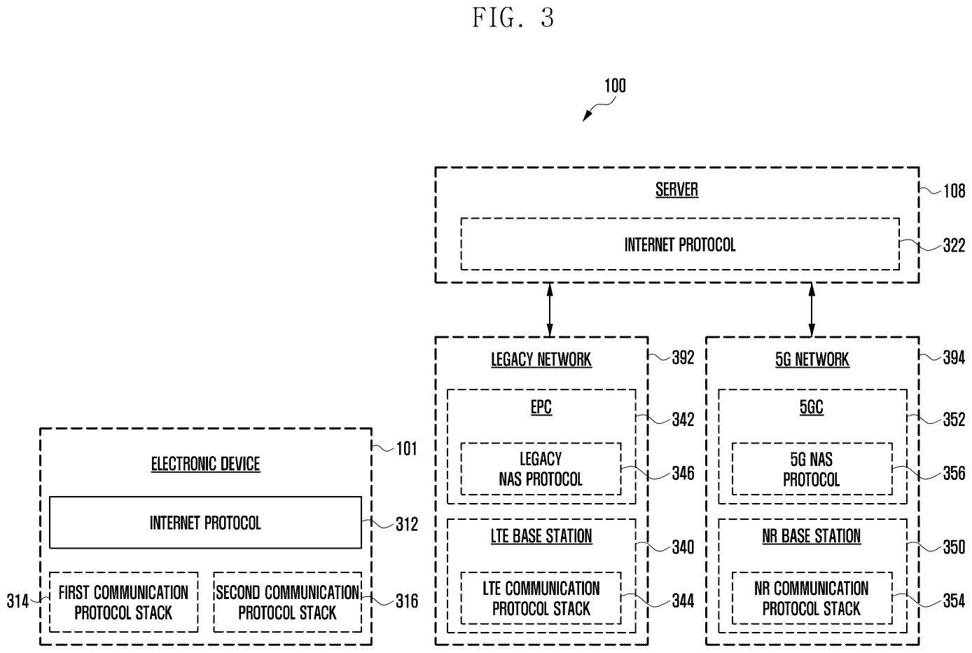

FIG. 3 is a diagram illustrating a protocol stack structure of a network of legacy communication and/or 5G communication according to an embodiment of the disclosure.

Referring to FIG. 3, a network 1100 according to the illustrated embodiment may include an electronic device 101, a legacy network 392, a 5G network 394, and a server 108.

The electronic device 101 may include an Internet protocol 312, a first communication protocol stack 314, and a second communication protocol stack 316. The electronic device 101 may communicate with the server 108 via the legacy network 392 and/or the 5G network 394.

According to an embodiment, the electronic device 101 may perform the Internet communication associated with the server 108 using the Internet protocol 312 (e.g., Transmission Control Protocol (TCP), User Datagram Protocol (UDP), Internet Protocol (IP)). The Internet protocol 312 may be executed, for example, in a main processor (e.g., the main processor 121 of FIG. 1) included in the electronic device 101.

According to another embodiment, the electronic device 101 may wirelessly communicate with the legacy network 392 using the first communication protocol stack 314. According to another embodiment, the electronic device 101 may wirelessly communicate with the 5G network 394 using the second communication protocol stack 316. The first communication protocol stack 314 and the second communication protocol stack 316 may be executed, for example, in one or more communication processors (e.g., the wireless communication module 192 of FIG. 1) included in the electronic device 101.

The server 108 may include an Internet protocol 322. The server 108 may transmit and receive data related to the Internet protocol 322 to and from the electronic device 101 via the legacy network 392 and/or the 5G network 394. According to an embodiment, the server 108 may include a cloud computing server that exists outside the legacy network 392 or the 5G network 394. In another embodiment, the server 108 may include an edge computing server (or a mobile edge computing (MEC) server) located inside at least one of the legacy network or the 5G network 394.

The legacy network 392 may include an LTE base station 340 and an EPC 342. The LTE base station 340 may include an LTE communication protocol stack 344. The EPC 342 may include a legacy non-access stratum (NAS) protocol 346. The legacy network 392 may use the LTE communication protocol stack 344 and the legacy NAS protocol 346 to perform the LTE wireless communication with the electronic device 101.

The 5G network 394 may include an NR base station 350 and a 5GC 352. The NR base station 350 may include an NR communication protocol stack 354. The 5GC 352 may include a 5G NAS protocol 356. The 5G network 394 may perform NR wireless communication with the electronic device 101 using the NR communication protocol stack 354 and the 5G NAS protocol 356.

According to an embodiment, the first communication protocol stack 314, the second communication protocol stack 316, the LTE communication protocol stack 344, and the NR communication protocol stack 354 may include a control plane protocol for transmitting and receiving a control message and a user plane protocol for transmitting and receiving user data. The control message may include, for example, a message related to at least one of security control, bearer establishment, authentication, registration, or mobility management. The user data may include, for example, the remaining data excluding the control message.

According to an embodiment, the control plane protocol and the user plane protocol may include physical (PHY), medium access control (MAC), radio link control (RLC), or packet data convergence protocol (PDCP) layers. The PHY layer may, for example, channel-code and modulate data received from a higher layer (e.g., MAC layer) and transmit the channel-coded and modulated data over a wireless channel, and demodulate and decode data received over the wireless channel and transmit the demodulated and decoded data to the higher layer. The PHY layer included in the second communication protocol stack 316 and the NR communication protocol stack 354 may further perform operations related to beam forming. The MAC layer may, for example, logically/physically mapped to a wireless channel over which data is to be transmitted and received, and perform hybrid automatic repeat request (HARQ) for error correction. The RLC layer may perform, for example, concatenation, segmentation, or reassembly of data, and perform order confirmation, reordering, or duplication confirmation of data. The PDCP layer may perform operations related to, for example, ciphering and data integrity of the control message and the user data. The second communication protocol stack 316 and the NR communication protocol stack 354 may further include a service data adaptation protocol (SDAP). The SDAP may manage radio bearer allocation based on, for example, the quality of service (QoS) of the user data.

According to various embodiments, the control plane protocol may include a radio resource control (RRC) layer and a non-access stratum (NAS) layer. The RRC layer may process control data related to, for example, radio bearer setup, paging, or mobility management. The NAS may process the control message related to, for example, the authentication, registration, and mobility management.

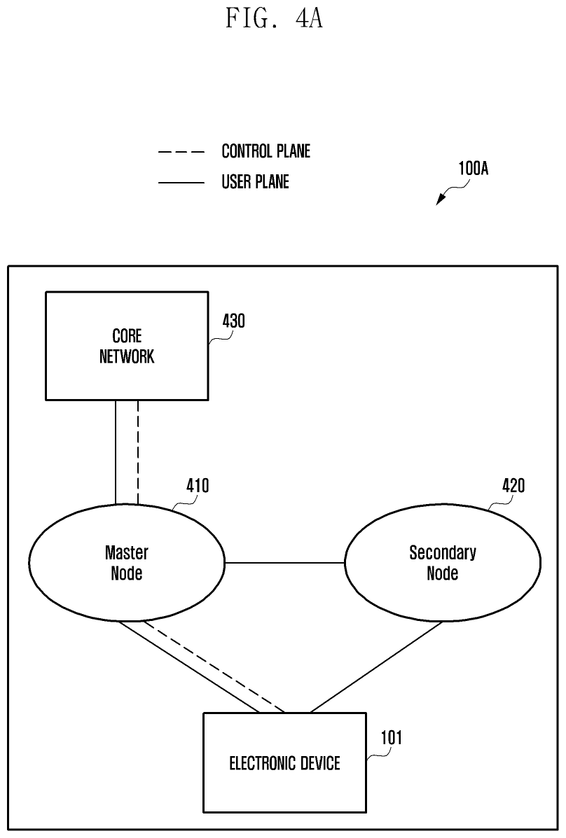

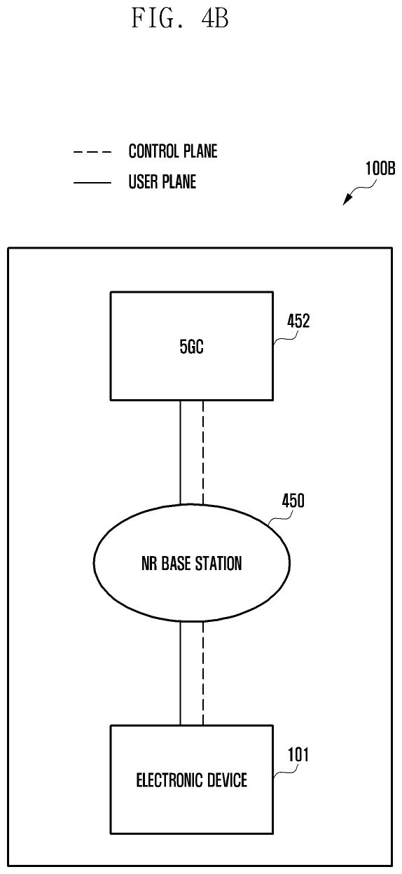

FIGS. 4A and 4B are diagrams illustrating wireless communication systems that provide networks of legacy communication and/or 5G communication according to various embodiments of the disclosure.

Referring to FIGS. 4A and 4B, network environments 100A to 100B may include at least one of a legacy network and a 5G network. The legacy network may include, for example, a 4G or LTE base station (e.g., an eNodeB (eNB)) of the 3GPP standard that supports the wireless connection with an electronic device 101 and an evolved packet core (EPC) that manages the 4G communication. The 5G network may include, for example, a new radio (NR) base station 450 (e.g., a gNodeB (gNB)) that supports the wireless connection with an electronic device 101 and a 5GC 452 (5th generation core) that manages the 5G communication of the electronic device 101.

According to various embodiments, the electronic device 101 may transmit and receive the control message and the user data via the legacy communication and/or the 5G communication. The control message may include, for example, a message related to at least one of security control, bearer setup, authentication, registration, or mobility management of the electronic device 101. The user data may refer, for example, to user data excluding the control message transmitted and received between the electronic device 101 and a core network 430.

Referring to FIG. 4A, the electronic device 101 according to an embodiment may transmit and receive at least one of the control message or the user data with at least a portion (e.g., the NR base station 450 and the 5GC 452) of the 5G network using at least a portion of the legacy network.

According to various embodiments, in a Multi-Radio Dual Connectivity (MR-DC) environment, one of the LTE base station or the NR base station, may operate as a master node (MN) 410, and the other may operate as a secondary node (SN) 420. The MN 410 may be connected to the core network 430 to transmit and receive the control message. The MN 410 and the SN 420 may be connected via a network interface to transmit and receive messages related to radio resource (e.g., communication channel) management to each other.

Referring to FIG. 4B, according to various embodiments, the 5G network may transmit and receive the control message and the user data independently of the electronic device 101.

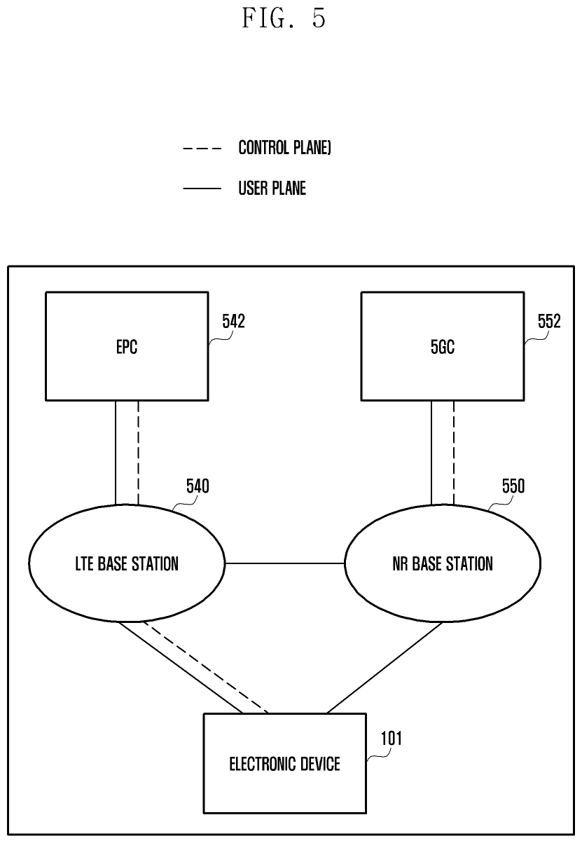

FIG. 5 is a diagram illustrating the electronic device and the cellular network according to an embodiment of the disclosure.

Referring to FIG. 5, according to various embodiments, the legacy network and the 5G network each may independently provide data transmission/reception. For example, an electronic device 101 and an EPC 542 may transmit and receive the control message and the user data via an LTE base station 540. For another example, the electronic device 101 and a 5GC 552 may transmit and receive the control message and the user data via an NR base station 550.

According to various embodiments, the electronic device 101 may be registered with at least one of the EPC 542 or the 5GC 552 to transmit and receive the control message.

According to various embodiments, the EPC 542 or the 5GC 552 may interwork to manage the communication of the electronic device 101. For example, the movement information of the electronic device 101 may be transmitted and received via an interface between the EPC 542 and the 5GC 552.

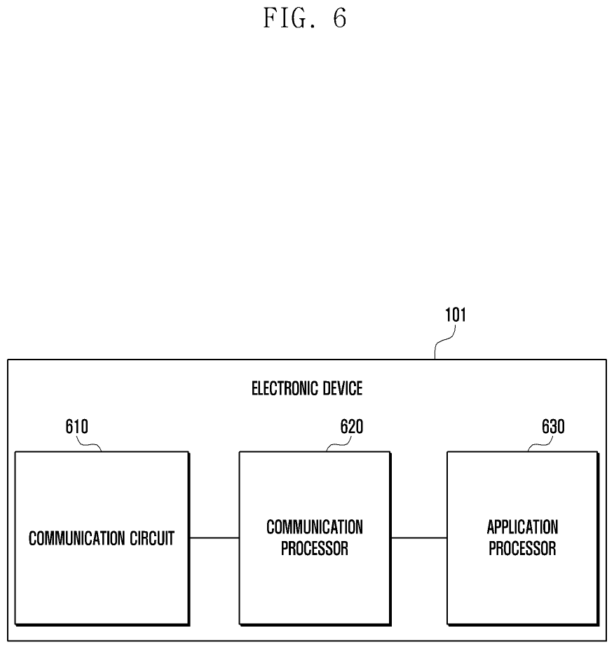

FIG. 6 is a diagram illustrating an electronic device according to an embodiment of the disclosure.

Referring to FIG. 6, an electronic device (e.g., the electronic device 101 of FIG. 1) may include a communication circuit 610, a communication processor (e.g., the first communication processor 212 of FIG. 2 and/or the second communication processor 214 of FIG. 2) 620, and/or an application processor (e.g., the processor 120 of FIG. 1) 630.

The application processor 630 may control various components of the electronic device 101. Specific operations will be described below.

The communication processor 620 may perform data transmission and/or reception via first cellular communication and/or second cellular communication. The communication processor 640 may be connected to a first node (e.g., a master node (MN) 410 of FIG. 4A) via the first cellular communication, or may be connected to a second node (e.g., a secondary node (SN) 420 of FIG. 4A) via the second cellular communication. The communication processor 620 may transmit the user data received from the application processor 630 via the first cellular communication and/or the second cellular communication, and may transmit the user data received via the first cellular communication and/or the second cellular communication to the application processor 630.

The first cellular communication may refer to any one of various cellular communication schemes that the electronic device 101 may support, for example, a communication scheme on the second network 294 of FIG. 2. For example, the first cellular communication may be a communication scheme using a 5th generation mobile communication scheme (e.g., the stand alone (SA)).

The second cellular communication may refer to any one of various cellular communication schemes that the electronic device (e.g., electronic device 101 of FIG. 1) may support, for example, a communication scheme on the first network 292 of FIG. 2. For example, the second cellular communication may be a communication scheme using a 4th generation mobile communication scheme (e.g., the non-stand alone (NSA)).

The electronic device 101 may process communication requests received from the IP multimedia subsystem (IMS) network and provide multimedia services to users, through the IMS registration process. The IMS registration process may be required each time the electronic device 101 is first connected to the IMS network or a user's location or a network connection changes.

The electronic device 101 may activate an IMS throttle timer when a connection failure occurs during a process of requesting the packet data network (PDN) connection for IMS registration. The IMS throttle timer may include a back-off timer that operates when the IMS protocol data unit (PDU) is rejected in the stand alone (SA) or the non-stand alone (NSA). The back-off timer is described in TS 24.501 section 6.4.1.4. The electronic device 101 may reattempt IMS PDU setup after the IMS throttle time has elapsed.

The electronic device 101 may receive the information about the IP multimedia subsystem (IMS) retry time using the communication processor 620 based on receiving the message indicating the failure to establish the communication connection or the message indicating no response. The electronic device 101 may determine to change the public land mobile network (PLMN) to which the connection is to be attempted based on whether or not the size of the IMS retry time and the size of the remaining IMS establishment time satisfy a designated condition under the control of the application processor 630.

According to an embodiment, the electronic device 101 may receive the information about the size of the IP multimedia subsystem (IMS) throttle time using the communication processor 620 under the control of the application processor 630. The application processor 630 may determine to change the public land mobile network (PLMN) to which the connection is to be attempted based on whether or not the size of the IMS throttle time and the size of the remaining IMS establishment time satisfy the designated condition. The IMS throttle time may include a waiting time to request the IMS PDU connection again when the IMS PDU connection request is rejected. According to an embodiment, when the PDN connection is rejected after the IMS registration request, the electronic device 101 may request the IMS registration again only after the IMS throttle time has elapsed.

According to an embodiment, the IMS establishment time may include a time during which the IMS registration may be attempted. The IMS establishment timer may refer to a timer for limiting the IMS registration attempt time. When the electronic device 101 fails to succeed in the IMS registration within the IMS establishment time, the electronic device 101 may attempt to switch to another network capable of providing a voice call service. The IMS establishment time is referred to as a “manufacturer determined period of time” in the 3GPP standard TS 24.501 section 4.3.2. The IMS establishment time may range from 2 to 12 minutes, for example, and may vary by an operator.

According to an embodiment, the conditions related to an operation of changing the public land mobile network (PLMN) to which the connection is to be attempted may include a condition where the size of the IMS throttle time exceeds the size of the remaining IMS establishment time. When the size of the IMS throttle time is relatively greater than the size of the remaining IMS establishment time, the electronic device 101 may attempt to switch to another PLMN because the electronic device 101 may not establish the IMS PDU connection during the remaining IMS establishment time. The electronic device 101 may change the public land mobile network (PLMN) to which the connection is to be attempted even if there is the remaining IMS establishment time.

According to an embodiment, the conditions related to the operation of changing the public land mobile network (PLMN) to which the connection is to be attempted may include a condition where the difference between the size of the IMS throttle time and the size of the remaining IMS establishment time is less than a designated level.

The application processor 630 may transmit to the communication processor 620 the message indicating the change in the PLMN to which the connection is to be attempted based on the determination to change the public land mobile network (PLMN) to which the connection is to be attempted. The communication processor 620 may receive priority information about the PLMN and determine whether or not the voice call service capable of being provided starting from a PLMN with a relatively high priority.

Based on the search of the PLMN capable of providing the voice call service, the communication processor 620 may attempt the communication connection with the searched PLMN.

According to an embodiment, the electronic device 101 may receive, using the communication processor 620, the message indicating the failure to establish the communication connection with the public land mobile network (PLMN) or the message indicating no response for the designated time. The electronic device 101 may receive the information about the IP multimedia subsystem (IMS) retry time using the communication processor 620 based on receiving the message indicating the failure to establish the communication connection or the message indicating no response. The electronic device 101 may determine to change the public land mobile network (PLMN) to which the connection is to be attempted based on whether or not the size of the IMS retry time and the size of the remaining IMS establishment time satisfy the designated condition under the control of the application processor 630.

According to an embodiment, the designated condition may include the condition where the size of the IMS retry time exceeds the size of the remaining IMS establishment time.

According to an embodiment, the designated condition may include the condition where the difference between the size of the IMS retry time and the size of the remaining IMS establishment time is less than the designated level.

The IMS retry time may include the time to wait for requesting the registration again when the registration request for the session initiation protocol (SIP) is rejected or there is no response while connected to the IP multimedia subsystem (IMS) protocol data unit (PDU). The IMS establishment time may include the time for attempting the IMS registration.

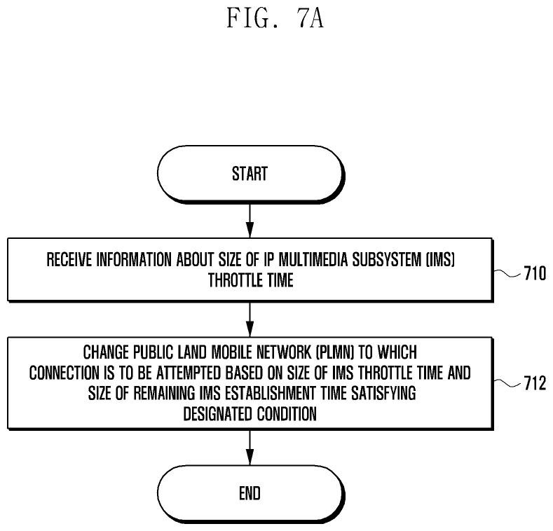

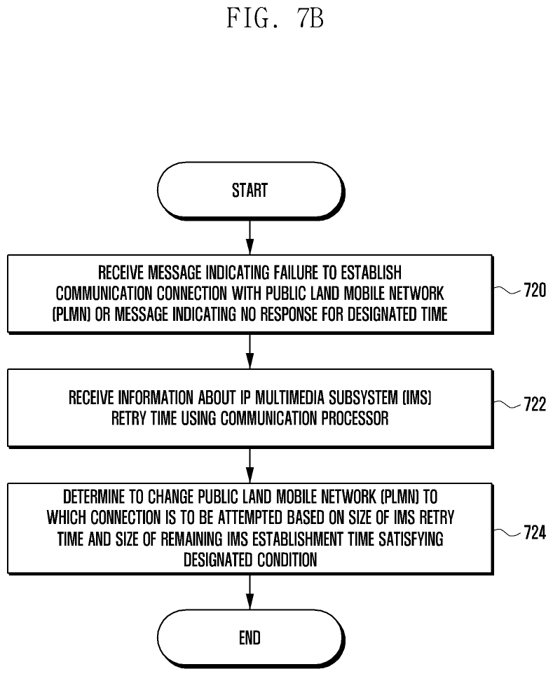

FIGS. 7A and 7B are flowcharts illustrating an operation method of an electronic device according to various embodiments of the disclosure.

The operations described with reference to FIGS. 7A and 7B may be implemented based on instructions that may be stored in a computer recording medium or memory (e.g., the memory 130 of FIG. 1). The method illustrated may be executed by the electronic device (e.g., electronic device 101 of FIG. 6) described above with reference to FIGS. 1 to 3, 4A, 4B, 5, and 6, and the technical features described above will be omitted below. The order of each operation of FIGS. 7A and 7B may be changed, some operations may be omitted, and some operations may be performed simultaneously.

In operation 710 of FIG. 7A, the electronic device 101 may receive the information about the size of the IP multimedia subsystem (IMS) throttle time using the communication processor (e.g., the communication processor 620 of FIG. 6).

The electronic device 101 may process the communication requests received from the IP multimedia subsystem (IMS) network and provide multimedia services to users, through the IMS registration process. The IMS registration process may be required each time the electronic device 101 is first connected to the IMS network or the user's location or the network connection changes.

The electronic device 101 may activate the IMS throttle timer when the connection failure occurs during the process of requesting the packet data network (PDN) connection for IMS registration. The IMS throttle timer may include the back-off timer that operates when the IMS protocol data unit (PDU) is rejected in the stand alone (SA) or the non-stand alone (NSA). The back-off timer is described in TS 24.501 section 6.4.1.4. The electronic device 101 may reattempt the IMS PDU setup after the IMS throttle time has elapsed. The IMS throttle time may include a waiting time to request the IMS PDU connection again when the IMS PDU connection request is rejected. According to an embodiment, when the PDN connection is rejected after the IMS registration request, the electronic device 101 may request the IMS registration again only after the IMS throttle time has elapsed.

In operation 712, the electronic device 101 may determine to change the public land mobile network (PLMN) to which the connection is to be attempted under the control of the application processor (e.g., application processor 630 of FIG. 6). The application processor 630 may determine to change the public land mobile network (PLMN) to which the connection is to be attempted based on the size of the IMS throttle time and the size of the remaining IMS establishment time satisfying the designated condition. The IMS establishment timer may refer to the timer for limiting the IMS registration attempt time. When the electronic device 101 fails to succeed in the IMS registration within the IMS establishment time, the electronic device 101 may attempt to switch to another network capable of providing the voice call service. The IMS establishment time is referred to as the “manufacturer determined period of time” in the 3GPP standard TS 24.501 section 4.3.2. The IMS establishment time may range from 2 to 12 minutes, for example, and may vary by an operator.

The designated condition may include, for example, the condition where the size of the IMS throttle time exceeds the size of the remaining IMS establishment time. The electronic device 101 may determine to change the public land mobile network (PLMN) to which the connection is to be attempted based on the size of the IMS throttle time exceeding the size of the remaining IMS establishment time. For example, when the size of the IMS throttle time is 10 minutes and the size of the remaining IMS establishment time is 5 minutes, the electronic device 101 may transmit the message requesting the PDN connection to a base station 805 again only after the IMS throttle time of 10 minutes has elapsed. However, when the remaining IMS establishment time is 5 minutes, the electronic device 101 may need to attempt to switch to another PLMN after 5 minutes have elapsed. When the electronic device 101 according to this document confirms that the size of the IMS throttle time exceeds the size of the remaining IMS establishment time, the electronic device 101 may attempt to switch to another PLMN, instead of waiting for the time corresponding to the size of the remaining IMS establishment time and then attempting to switch to another PLMN. The electronic device 101 according to this document may increase the network switching speed by relatively quickly attempting to switch to another PLMN in the situations where it is difficult to provide the voice call service. The electronic device 101 may reset all the IMS throttle time, the IMS establishment time, and the IMS retry time based on the completion of the switch to another PLMN.

The designated condition may include, for example, a condition where the difference between the size of the IMS throttle time and the size of the remaining IMS establishment time is less than a designated level.

The electronic device 101 may determine to change the public land mobile network (PLMN) to which the connection is to be attempted when the difference between the size of the IMS throttle time and the size of the remaining IMS establishment time is less than a designated level (e.g., 1 minute). For example, in a situation where the size of the IMS throttle time is 10 minutes and the size of the remaining IMS establishment time is 10 minutes and 30 seconds, the electronic device 101 may determine to change the public land mobile network (PLMN) to which the connection is to be attempted based on the difference between the size of the IMS throttle time and the size of the remaining IMS establishment time being less than a designated level (e.g., 1 minute). The electronic device 101 may reset all the IMS throttle time, the IMS establishment time, and the IMS retry time based on the completion of the switch to another PLMN.

According to an embodiment, the electronic device 101 may control the communication circuit 610 to initiate, using the communication processor 620, a connection procedure with the IP multimedia subsystem (IMS) via the cellular network, activate the IMS establishment timer that detects whether or not the IMS establishment time, which is a time indicating a maximum time required for the electronic device to be connected to the IMS, has expired, and transmit, to the cellular network, a message (e.g., a PDN connectivity request message) requesting the packet data network (PDN) connection between the IMS and the electronic device to the cellular network. The message requesting the packet data network (PDN) connection between the IMS and the electronic device 101 may include a PDN connectivity request in the case of the non-stand alone (NSA) and a PDU session establishment request in the case of the stand alone (SA). The electronic device 101 may receive a message rejecting the PDN connection from the cellular network and transmit the message to the application processor 630. The message rejecting the PDN connection may include a PDN connectivity reject in the case of the non-stand alone (NSA) and a PDU session establishment reject in the case of the stand alone (SA). Under the control of the application processor 630, upon reception of the message rejecting the PDN connection, the electronic device 101 may compare the waiting time to reattempt the PDN connection with the remaining time of the IMS establishment time, and based on the result of the comparison, attempt to connect to a cellular network (e.g., another PLMN) different from the cellular network with which the current connection is established.

According to an embodiment, when the waiting time to reattempt the PDN connection is greater than the remaining time of the IMS establishment time, the application processor 630 may attempt the connection to the cellular network different from the cellular network.

According to an embodiment, when the waiting time to reattempt the PDN connection is greater than the remaining time of the IMS establishment time, the application processor 630 may attempt to connect to the cellular network different from the cellular network without reattempting the PDN connection.

According to an embodiment, the communication processor 620 may select one of the plurality of other cellular networks based on priorities of each of the plurality of other cellular networks as part of attempting the connection to the cellular network different from the cellular network and confirm whether or not the selected cellular network capable of providing a designated service.

According to an embodiment, the designated service may include the voice call service.

In operation 720 of FIG. 7B, the electronic device 101 may receive, using the communication processor 620, the message indicating the failure to establish the communication connection with the public land mobile network (PLMN) or the message indicating no response for the designated time from the base station (e.g., the server 108 of FIG. 3).

In operation 722, the electronic device 101 may receive the information about the IP multimedia subsystem (IMS) retry time using the communication processor 620. The electronic device 101 may operate an IMS registration retry timer based on receiving a message indicating that an error has occurred for the session initiation protocol (SIP) registration or determining that there is no response. The IMS registration retry timer may be used to measure the IMS retry time. The IMS retry time may include the time to wait for requesting the registration again when the registration request for the session initiation protocol (SIP) is rejected or there is no response while connected to the IP multimedia subsystem (IMS) protocol data unit (PDU).

In operation 724, the electronic device 101 may determine to change the public land mobile network (PLMN) to which the connection is to be attempted based on the size of the IMS retry time and the size of the remaining IMS establishment time satisfying the designated condition under the control of the application processor 630.

The designated condition may include the condition where the size of the IMS retry time exceeds the size of the remaining IMS establishment time. The designated condition may include the condition where the difference between the size of the IMS retry time and the size of the remaining IMS establishment time is less than a designated level.

For example, when the size of the IMS retry time is 10 minutes and the size of the remaining IMS establishment time is 5 minutes, the electronic device 101 may transmit the message requesting the PDN connection to a base station 805 again only after the IMS retry time of 10 minutes has elapsed. However, when the remaining IMS establishment time is 5 minutes, the electronic device 101 may need to attempt to switch to another PLMN after 5 minutes have elapsed. The electronic device 101 according to this document may attempt to immediately switch to another PLMN, rather than waiting for the time corresponding to the size of the remaining IMS establishment time and then attempting to switch to another PLMN in the situation where the size of the IMS retry time exceeds the size of the remaining IMS establishment time. The electronic device 101 according to this document may increase the network switching speed by relatively quickly attempting to switch to another PLMN in the situations where it is difficult to provide the voice call service.

The electronic device 101 may determine to change the public land mobile network (PLMN) to which the connection is to be attempted when the difference between the size of the IMS retry time and the size of the remaining IMS establishment time is less than a designated level (e.g., 1 minute). For example, in the situation where the size of the IMS retry time is 10 minutes and the size of the remaining IMS establishment time is 10 minutes and 30 seconds, the electronic device 101 may determine to change the public land mobile network (PLMN) to which the connection is to be attempted based on the difference between the size of the IMS retry time and the size of the remaining IMS establishment time being less than the designated level (e.g., 1 minute).

The electronic device 101 may reset all the IMS throttle time, the IMS establishment time, and the IMS retry time based on the completion of the switch to another PLMN.

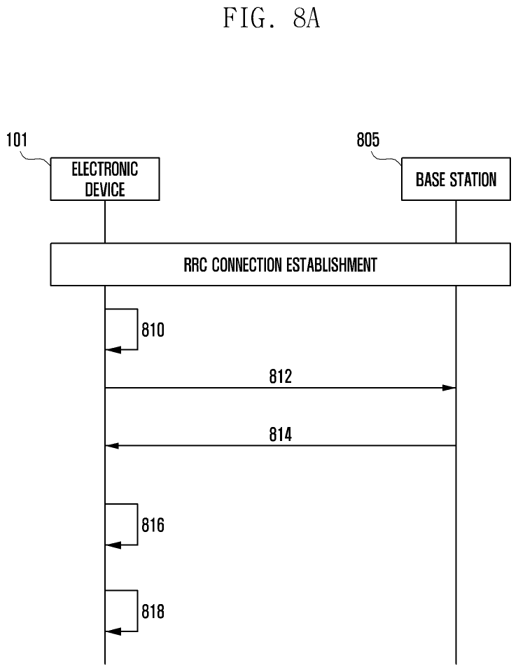

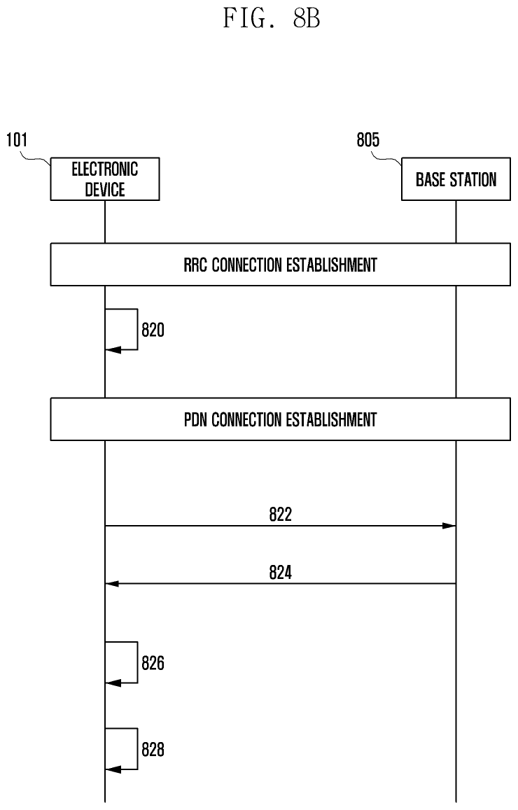

FIG. 8A illustrates a first embodiment in which a determination is made to attempt a switching to another PLMN based on an IMS throttle timer value and an IMS establishment timer value according to an embodiment of the disclosure.

FIG. 8B illustrates a second embodiment in which a determination is made to attempt switching to another PLMN based on the IMS registration retry timer value and the IMS establishment timer value according to an embodiment of the disclosure.

The operations described with reference to FIGS. 8A and 8B may be implemented based on instructions that may be stored in a computer recording medium or memory (e.g., the memory 130 of FIG. 1). The method illustrated may be executed by the electronic device (e.g., electronic device 101 of FIG. 6) described above with reference to FIGS. 1 to 3, 4A, 4B, 5, and 6, and the technical features described above will be omitted below. The order of each operation of FIGS. 8A and 8B may be changed, some operations may be omitted, and some operations may be performed simultaneously.

Referring to FIG. 8A, an electronic device 101 may establish a radio resource control (RRC) connection with a base station 805. The radio resource control (RRC) may refer to a protocol used when the user terminal communicates with the wireless base station. The base station 805 may include, for example, the LTE base station 540 and the NR base station 550 of FIG. 5.

In operation 810, the electronic device 101 may operate the IMS establishment timer based on the establishment of the RRC connection with the base station 805. The IMS establishment time may refer to the limited time during which the IMS registration may be attempted. Based on the failure to successfully complete the IMS registration within the preset IMS establishment time, the electronic device 101 may attempt to switch to another PLMN.

In operation 812, the electronic device 101 may transmit the message requesting the packet data network (PDN) connection to the base station 805. The packet data network (PDN) may include a network used for data communication in a mobile communication system. The electronic device 101 may use the PDN to use an online service including at least one of mobile app, email, social media, or streaming service. The electronic device 101 may use the PDN to perform data communication with a mobile communication network. The electronic device 101 may use the PDN to transmit and receive data packets to and from the base station 805.

In operation 814, the electronic device 101 may receive, from the base station 805, the message indicating that the PDN connection has been rejected.

In operation 816, the electronic device 101 may operate the IMS PDU throttle timer based on receiving the message indicating that the PDN connection has been rejected. The IMS PDU throttle timer may be used to measure the IMS throttle time. The IMS throttle time may refer to the waiting time to request the IMS PDU connection again when the IMS PDU connection request is rejected. The IMS throttle time may increase together as the number of rejections of the IMS PDU connection request increases. For example, the IMS throttle time may increase to 5 minutes when the IMS PDU connection request is rejected once, to 10 minutes when rejected twice, and to 30 minutes when rejected three times. This is merely an example, and the IMS throttle time may vary depending on the configuration.

In operation 818, the electronic device 101 may determine to change the public land mobile network (PLMN) to which the connection is to be attempted based on whether or not the size of the IMS throttle time and the size of the IMS establishment time satisfy the designated condition under the control of the application processor (e.g., the application processor 630 of FIG. 6).

The designated condition may include, for example, the condition where the size of the IMS throttle time exceeds the size of the remaining IMS establishment time. The electronic device 101 may determine to change the public land mobile network (PLMN) to which the connection is to be attempted based on the size of the IMS throttle time exceeding the size of the IMS establishment time. For example, when the size of the IMS throttle time is 10 minutes and the size of the remaining IMS establishment time is 5 minutes, the electronic device 101 may transmit the message requesting the PDN connection to the base station 805 again only after the IMS throttle time of 10 minutes has elapsed. However, when the remaining IMS establishment time is 5 minutes, the electronic device 101 may need to attempt to switch to another PLMN after 5 minutes have elapsed. The electronic device 101 according to this document may attempt to immediately switch to another PLMN, rather than waiting for the time corresponding to the size of the remaining IMS establishment time and then attempting to switch to another PLMN in the situation where the size of the IMS throttle time exceeds the size of the remaining IMS establishment time. The electronic device 101 according to this document may increase the network switching speed by relatively quickly attempting to switch to another PLMN in the situations where it is difficult to provide the voice call service.

The designated condition may include, for example, a condition where the difference between the size of the IMS throttle time and the size of the remaining IMS establishment time is less than a designated level.

The electronic device 101 may determine to change the public land mobile network (PLMN) to which the connection is to be attempted when the difference between the size of the IMS throttle time and the size of the remaining IMS establishment time is less than a designated level (e.g., 1 minute). For example, in a situation where the size of the IMS throttle time is 10 minutes and the size of the remaining IMS establishment time is 10 minutes and 30 seconds, the electronic device 101 may determine to change the public land mobile network (PLMN) to which the connection is to be attempted based on the difference between the size of the IMS throttle time and the size of the remaining IMS establishment time being less than a designated level (e.g., 1 minute).

The electronic device 101 may reset all the IMS throttle time, the IMS establishment time, and the IMS retry time based on the completion of the switch to another PLMN.

FIG. 8B illustrates a second embodiment in which a determination is made to attempt switching to another PLMN based on the IMS registration retry timer value and the IMS establishment timer value according to an embodiment of the disclosure.

Referring to FIG. 8B, an electronic device 101 may establish the radio resource control (RRC) connection with a base station 805. The radio resource control (RRC) may include a protocol used when the user terminal communicates with the wireless base station. The base station 805 may include, for example, the LTE base station 540 and the NR base station 550 of FIG. 5.

In operation 820, the electronic device 101 may operate the IMS establishment timer based on the establishment of the RRC connection with the base station 805. The IMS establishment timer may be used to measure the IMS establishment time. The IMS establishment time may refer to the limited time during which the IMS registration may be attempted. The electronic device 101 may attempt to switch to another network based on failing to successfully complete the IMS registration within the preset IMS establishment time.

The electronic device 101 may establish the packet data network (PDN) connection with the base station 805. The packet data network (PDN) may include the network used for the data communication in the mobile communication system. The electronic device 101 may use the PDN to use the online service including at least one of the mobile app, email, social media, or streaming service. The electronic device 101 may use the PDN to perform the data communication with the mobile communication network. The electronic device 101 may use the PDN to transmit and receive the data packets to and from the base station 805.

In operation 822, the electronic device 101 may transmit the message requesting the session initiation protocol (SIP) registration to the base station 805.

In operation 824, the electronic device 101 may receive, from the base station 805, a message indicating that an error has occurred in the session initiation protocol (SIP) registration. Alternatively, the electronic device 101 may determine that there is no response based on not receiving a response to the message requesting the session initiation protocol (SIP) registration from the base station 805 within the designated time.

In operation 826, the electronic device 101 may operate an IMS registration retry timer based on receiving a message indicating that an error has occurred for the session initiation protocol (SIP) registration or determining that there is no response. The IMS registration retry timer may be used to measure the IMS retry time. The IMS retry time may include the time to wait for requesting the registration again when the registration request for the session initiation protocol (SIP) is rejected or there is no response while connected to the IP multimedia subsystem (IMS) protocol data unit (PDU).

In operation 828, the electronic device 101 may determine to change the public land mobile network (PLMN) to which the connection is to be attempted based on whether or not the size of the IMS retry time and the size of the remaining IMS establishment time satisfy the designated condition. The designated condition may include the condition where the size of the IMS retry time exceeds the size of the remaining IMS establishment time. The designated condition may include the condition where the difference between the size of the IMS retry time and the size of the remaining IMS establishment time is less than a designated level.

For example, when the size of the IMS retry time is 10 minutes and the size of the remaining IMS establishment time is 5 minutes, the electronic device 101 may transmit the message requesting the PDN connection to the base station 805 again only after the IMS retry time of 10 minutes has elapsed. However, when the remaining IMS establishment time is 5 minutes, the electronic device 101 may need to attempt to switch to another PLMN after 5 minutes have elapsed. The electronic device 101 according to this document may attempt to immediately switch to another PLMN, rather than waiting for the time corresponding to the size of the remaining IMS establishment time and then attempting to switch to another PLMN in the situation where the size of the IMS retry time exceeds the size of the remaining IMS establishment time. The electronic device 101 according to this document may increase the network switching speed by relatively quickly attempting to switch to another PLMN in the situations where it is difficult to provide the voice call service.

The electronic device 101 may determine to change the public land mobile network (PLMN) to which the connection is to be attempted when the difference between the size of the IMS retry time and the size of the remaining IMS establishment time is less than a designated level (e.g., 1 minute). For example, in the situation where the size of the IMS retry time is 10 minutes and the size of the remaining IMS establishment time is 10 minutes and 30 seconds, the electronic device 101 may determine to change the public land mobile network (PLMN) to which the connection is to be attempted based on the difference between the size of the IMS retry time and the size of the remaining IMS establishment time being less than the designated level (e.g., 1 minute).

The electronic device 101 may reset all the IMS throttle time, the IMS establishment time, and the IMS retry time based on the completion of the switch to another PLMN.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a communication circuit configured to transmit and receive data via a cellular network;
an application processor; and
a communication processor,
wherein the application processor is configured to:
based on receiving a message from the communication processor, activate an internet protocol (IP) multimedia subsystem (IMS) establishment timer that detects whether or not an IMS establishment time, which is a time indicating a maximum time required for the electronic device to be connected to an IMS, has expired,
transmit, to the cellular network by using the communication circuit, a packet data network (PDN) connectivity request message requesting a PDN connection between the IMS and the electronic device,
in response to receiving a message rejecting the PDN connection, compare a waiting time to reattempt the PDN connection with a remaining time of the IMS establishment time, and
based on a result of the comparing, determine to attempt a connection to at least one cellular network different from the cellular network.

2. The electronic device of claim 1, wherein the application processor is further configured to:
when the waiting time to reattempt the PDN connection is greater than the remaining time of the IMS establishment time, attempt the connection to the at least one cellular network different from the cellular network.

3. The electronic device of claim 1, wherein the application processor is further configured to:
when the waiting time to reattempt the PDN connection is greater than the remaining time of the IMS establishment time, attempt the connection to the at least one cellular network different from the cellular network without reattempting the PDN connection.

4. The electronic device of claim 1, wherein the communication processor is configured to:
select one of a plurality of other cellular networks based on priorities of each of the plurality of other cellular networks as part of attempting the connection to the at least one cellular network different from the cellular network; and
confirm whether or not the selected cellular network provides a designated service.

5. The electronic device of claim 4, wherein the designated service includes a voice call service.

6. An electronic device comprising:
a communication processor; and
an application processor,
wherein the application processor is configured to:
receive, using the communication processor, a message indicating a failure to establish a communication connection with a public land mobile network (PLMN) or a message indicating no response for a designated time,
based on receiving the message indicating the failure to establish the communication connection or the message indicating no response for the designated time, receive, using the communication processor, information about an internet protocol (IP) multimedia subsystem (IMS) retry time, and
based on a size of the IMS retry time and a size of a remaining IMS establishment time satisfying a designated condition, determine to change the PLMN to which the communication connection is to be attempted.

7. The electronic device of claim 6, wherein the designated condition includes a condition in which the size of the IMS retry time exceeds the size of the remaining IMS establishment time.

8. The electronic device of claim 6, wherein the designated condition includes a condition in which a difference between the size of the IMS retry time and the size of the remaining IMS establishment time is less than a designated level.

9. The electronic device of claim 6, wherein the communication processor searches for the PLMN providing a voice call service based on a determination to change the PLMN to which the communication connection is to be attempted.

10. The electronic device of claim 9, wherein the communication processor attempts the communication connection with the searched PLMN using the communication processor based on that the PLMN providing a voice call service is searched.

11. The electronic device of claim 6,
wherein the IMS retry time includes a time to wait for requesting an IMS registration again when a registration request for a session initiation protocol (SIP) is rejected or there is no response while connected to an IMS protocol data unit (PDU), and
wherein the IMS establishment time includes a time for attempting the IMS registration.

12. A method performed by an electronic device, the method comprising:
activating, by the electronic device, an internet protocol (IP) multimedia subsystem (IMS) establishment timer that detects whether the IMS establishment time, which is a time indicating a maximum time required for the electronic device to be connected to the IMS, has expired while initiating a connection procedure with the IMS via a cellular network;
controlling, by the electronic device, a communication processor to transmit, to the cellular network, a packet data network (PDN) connectivity request message requesting a PDN connection between the IMS and the electronic device;
receiving, from the cellular network, a message rejecting the PDN connection;
in response to receiving the message rejecting the PDN connection, comparing, by the electronic device, a waiting time to reattempt the PDN connection with a remaining time of the IMS establishment time; and
based on a result of the comparing, determining, by the electronic device, to attempt a connection to at least one cellular network different from the cellular network.

13. The method of claim 12, further comprising:
when the waiting time to reattempt the PDN connection is greater than the remaining time of the IMS establishment time, configuring, by the electronic device, to attempt the connection to the at least one cellular network different from the cellular network.

14. The method of claim 12, further comprising:
when the waiting time to reattempt the PDN connection is greater than the remaining time of the IMS establishment time, attempting the connection to the at least one cellular network different from the cellular network without reattempting the PDN connection.

15. The method of claim 12, further comprising:
selecting, by the electronic device, one of a plurality of other cellular networks based on priorities of each of the plurality of other cellular networks as part of attempting the connection to the at least one cellular network different from the cellular network; and
confirming, by the electronic device, whether or not the selected cellular network provides a designated service.

16. The method of claim 15, wherein the designated service includes a voice call service.

17. The method of claim 12, further comprising:
receiving, by the electronic device, a message indicating a failure to establish a communication connection with a public land mobile network (PLMN) or a message indicating no response for a designated time;
based on receiving the message indicating the failure to establish the communication connection or the message indicating no response, receiving, by the electronic device using the communication processor, information about an IMS retry time; and
determining, by the electronic device, to change the PLMN to which the connection is to be attempted based on a size of the IMS retry time and a size of a remaining IMS establishment time satisfying a designated condition.

18. The method of claim 17, wherein the designated condition includes a condition in which the size of the IMS retry time exceeds the size of the remaining IMS establishment time.

19. The method of claim 17, wherein the designated condition includes a condition in which a difference between the size of the IMS retry time and the size of the remaining IMS establishment time is less than a designated level.

20. The method of claim 17, further comprising:
searching for the PLMN providing a voice call service based on determining to change the PLMN to which the connection is to be attempted.
